(19) United States
(12) Patent Application Publication
(10) Pub. No.: US 2016/0344260 A1
(43) Pub. Date: Nov. 24, 2016

(54) LIVESTOCK POWER GENERATION SYSTEM

(71) Applicant: Te-Chih CHANG, New Taipei City (TW)

(72) Inventor: Te-Chih CHANG, New Taipei City (TW)

(21) Appl. No.: 14/885,340

(22) Filed: Oct. 16, 2015

(30) Foreign Application Priority Data
May 18, 2015 (TW) 104115836

(51) Int. Cl. H02K 7/18; H02P 9/08; A01K 29/00; H02P 9/04

(52) U.S. Cl. CPC H02K 7/1861; H02P 9/04; H02P 9/08; A01K 29/00

(57) ABSTRACT

The present invention discloses a livestock power generation system which generates electricity by using the habit of the livestock to produce rotational power to cut through electric current. The livestock power generation system is provided with equiangular radial levers to generate a moment of force by the marching of the livestock, which drives the livestock power generation system to rotate to generate electricity. In addition, by the assistance and management of an urging device and a stopping device, the operation of power generation by the livestock can be more stable.

### BACKGROUND OF THE INVENTION

a) Field of the Invention

The present invention relates to a power generation system, and more particularly to a livestock power generation system, wherein a main body thereof is a passive device disposed on a land surface. The passive device is provided radially and equiangularly with radial levers which are linked to the livestock, such that by the habit that the livestock will march forward continuously, the passive device can be operated to produce electric current continuously.

b) Description of the Prior Art

The apparatus which is operated electrically or electronically increases significantly and the requirement for the electricity also increases daily following the rapid increase of population. Although the green energy technology can be used to generate power, the production of optoelectronic devices must be industrialized and the efficiency of green energy power generation technology is still too low to catch up with the conventional power generation system. Nowadays, power can be produced by the green infrastructures such as wind power, tidal power or hydraulic power, etc.

It should be paid attention to that the dynamic energy produced by the livestock is capable of replacing mass energy, as the amount of the livestock is huge. Accordingly, in a Taiwanese Patent No. 103204182, a treadmill-like apparatus is utilized and feeds are provided to lure the livestock to march forward, thereby producing electricity. However, as time increases, the power of attraction will decrease and the livestock can see through it easily. Therefore, manpower will be used to push the livestock to march forward, so that the operation can continue.

### SUMMARY OF THE INVENTION

The primary object of the present invention is to provide a livestock power generation system, wherein a power generation system is disposed on a land surface to form planar revolution by the motion of the livestock to produce electricity.

Another object of the present invention is to provide a livestock power generation system, wherein an end of each radial lever is assembled with a traction device which can be flipped up on a plane. The traction device provides for the link to the livestock power and facilitates the operation of connection and dismantlement.

A third object of the present invention is to provide a livestock power generation system, wherein a rear end of the traction device is provided with an urging device which can push the livestock to march forward, thereby maintaining the steady operation when the livestock is lazy.

A fourth object of the present invention is to provide a livestock power generation system, wherein an end of the traction device is provided with a stopping device which commands the livestock to work through a rein.

A fifth object of the present invention is to provide a livestock power generation system, wherein the power generation system is provided with an electromechanical induction and control device to aid in the operational management.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a top view of implementation of a livestock power generation system, according to the present invention.

FIG. 2 shows a side view of a passive device of the present invention.

FIG. 3 shows a schematic view of livestock being utilized to link to the livestock power generation system, according to the present invention.

FIG. 4 shows a schematic view of a partial structure of an urging device, according to the present invention.

FIG. 5 shows a flow diagram of electromechanical control of the present invention.

FIG. 6 shows a schematic view of implementation of the livestock power generation system operating along another direction, according to the present invention.

### DETAILED DESCRIPTION OF THE PREFERRED EMBODIMENTS

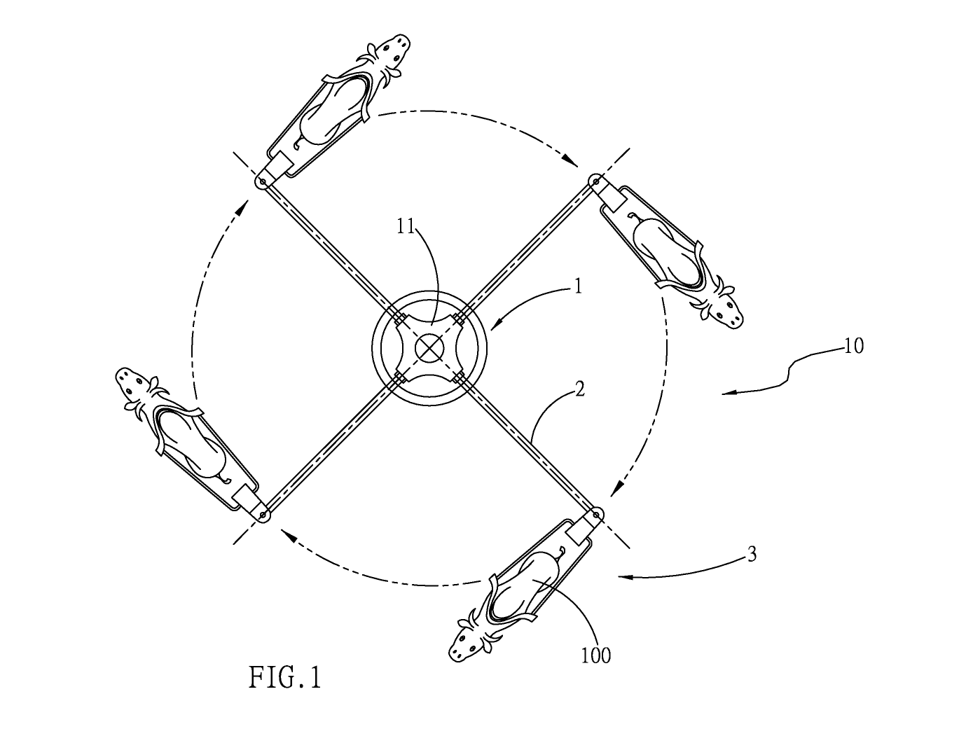

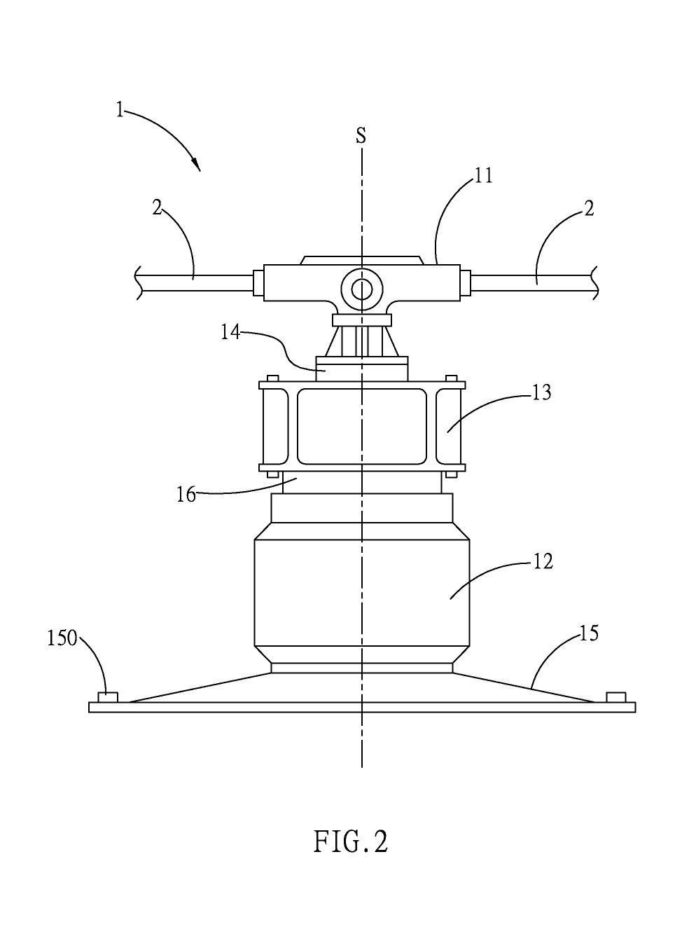

Referring to FIG. 1 and FIG. 2, the present invention discloses a livestock power generation system 10 which excites into power utilizing the habit of livestock 100 that the livestock 100 will revolve obediently.

The main body of the livestock power generation system 10 is a passive device 1 which is mounted on a land surface. The passive device 1 is provided with a radial seat 11 which is extended horizontally, radially and equiangularly with radial levers 2. A tail end of the radial lever 2 is linked to the livestock 100 through a traction device 3 to form planar revolution using the habit of the livestock 100 that the livestock 100 will march forward continuously, thereby driving a power generation unit 12 of the passive device 1 to excite into electric current, wherein a working axis S of the passive device 1 is perpendicular to the land surface. The radial seat 11 is disposed at an upper end of the passive device 1 horizontally to link to the power generation unit 12 through a gearshift 13. The linking axis can be also added with a conventional flywheel to stabilize the rotational speed (not shown in the drawings), so that the livestock power generation system 10 can be operated more stably. A bottom of the passive device 1 is provided with a chassis 15 which is crossed over on the land surface and is fixed by a fixing device 150.

The passive device 1 is provided with a brake device 16, the gearshift 13 and a rotational speed inductor 14. The brake device 16 is operated along the working axis S, the gearshift 13 provides the radial seat 11 with rotational speed, and produces the ratio of revolution along with the power generation unit 12. The brake device 16 is able to stop the livestock power generation system 10 when a manager decides to shut down the system. The brake device 16 stops the system by friction and is a conventional mechanism using a mechanical link or electric detent, as long as the power generation unit 12 can be stopped.

The provided rotational speed inductor 14 can sense the operational speed of the passive device 1 which is driven on a plane. The rotational speed inductor 14 can be also electronic, taking the change of electric current value from the power generation unit 12 as a reference of calculation to contrast into the required working data. As the provision of the rotational speed inductor 14 is an ordinary electromechanical technology, no further description is disclosed.

The radial seat 11 is disposed radially and equiangularly. Each equiangular position is extended with a radial lever 2, and a tail end of the radial lever 2 provides for drawing the livestock 100 in a corresponding amount. The livestock power generation system 10 can be also driven by a single head of the livestock 100. However, the component of force will be formed in the livestock power generation system 10 as the livestock power generation system 10 rotates eccentrically, which will consume the total working energy of the livestock 100.

The livestock power generation system 10 is provided with the radial levers 2 which are distributed radially and equiangularly. The livestock 100 to be drawn are drawn by an applied force at a symmetric point. For example, if there are at least two symmetric radial levers 2 passing through the center of the livestock power generation system 10 and the tail ends of the radial levers 2 draw the livestock 100 symmetrically, then the radial seat 11 of the passive device 1 will be preferably separated radially into two, which is easier to achieve the work combination where the component of force is equally distributed to the symmetric angles.

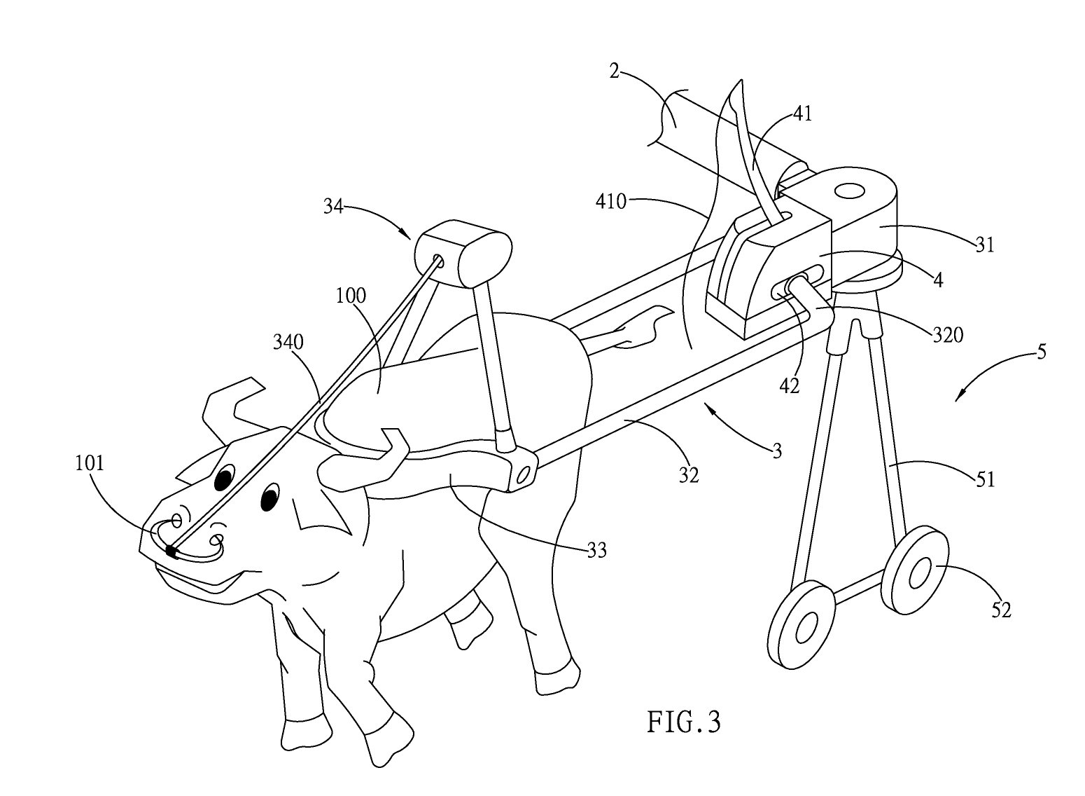

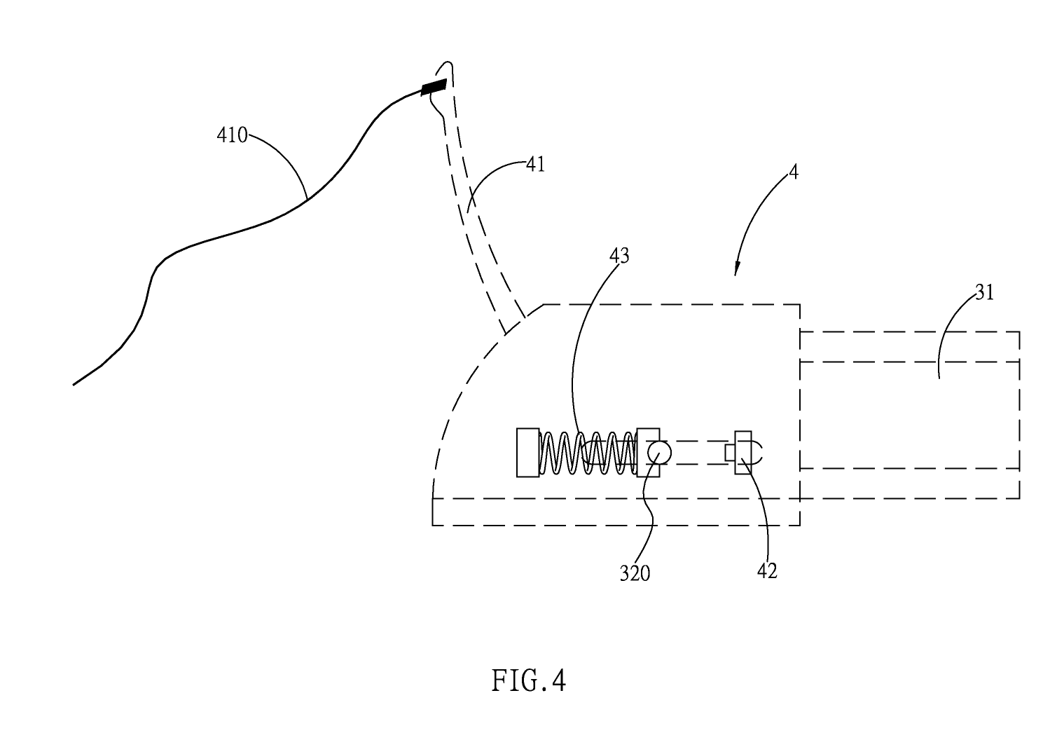

Furthermore, referring to FIG. 3 and FIG. 4, the tail end of the radial lever 2 is connected horizontally to the traction device 3 through a planar connection seat 31 to link to the livestock 100. By the command of the manager, the livestock 100 will march forward continuously due to the habit of motion thereof, which forms the revolution as shown in FIG. 1 to drive the passive device 1 to excite into power.

As the livestock 100 is provided with inertia, a rear end thereof can be provided with an urging device 4 which pushes the livestock 100 to march forward by simulating whipping. The urging device 4 is provided with a pull sensor 42, the change of which is based upon the front and rear displacement of a connection rod 320 at a rear end of a front thill 32, after the connection rod 320 has been pulled. When the front thill 32 is pulled forward, the pull sensor 42 does not response, meaning that the livestock 100 works steadily, and the drawing force is transmitted to the radial lever 2 through the planar connection seat 31, in order to operate the livestock power generation system 10. On the other hand, when the livestock 100 is lazy and marches slowly, the connection rod 320 of the front thill 32 will move backward to trigger the pull sensor 42. The pull sensor 42 will then generate a signal to command a sling rod 41 to swing. A tail end of the sling rod 41 is fastened with a whip 410. When the sling rod 41 swings downward, the whip 410 will swing onto a hip of the livestock 100 and the livestock 100 will feel being driven to march forward with effort.

The power of the sling rod 41 to swing the whip 410 can derive from an ordinary electric device which is operated electromagnetically, such as a magnetic repulsive mechanism or an electric motor.

The pull sensor 42 disposed inside the urging device 4 can be an ordinary switch which is operated by electric contact. The pull sensor 42 is supported by an interface of a spring 43 disposed inside the urging device 4. When the spring 43 is not compressed, the right surface of the connection rod 320 will press the pull sensor 42 which generates an electric signal to command whipping. On the other hand, if the spring 43 is compressed, then the surface of the connection rod 320 will escape from the pull sensor 42, meaning that the livestock 100 is working very hard.

The force of the front thill 32 is linked to the planar connection seat 31 through the connection rod 320 and the spring 43. The planar connection seat 31 transmits the force to the radial lever 2, causing the lever action to drive the livestock power generation system 10 to produce electricity.

The livestock power generation system 10 stops the operation by an assistance of a stopping device 34 which will command the livestock 100 to stop working. The method is to close the working loop of the pull sensor 42 and in the meantime to command the stopping device 34 to operate. The stopping device 34 is provided outward with a rein 340 and a tail end of the rein 340 is linked to an external fitting 101 which can command the livestock 100 to stop marching. This process starts from that the livestock power generation system 10 issues a command of shutdown and then the stopping device 34 produces power to pull the rein 340 continuously or by inches, commanding the livestock 100 to stop and rest driven by the external fitting 101.

To simulate the working habit of a cow, donkey or horse, an automatic on-site commanding device is designed corresponding to the abovementioned working status where the whip 410 is used to push the livestock 100 and the rein 340 is used to prompt the livestock 100. The stopping device 34 receives the working command through the connection of circuit, and the urging device 4 generates an electromechanical action through the connection of electricity.

The livestock 100 can be bond and linked to the livestock power generation system 10 by a flexible band or any method. In the present embodiment, the livestock 100 is sheathed by the traction device 3 to link to the radial lever 2. A provided yoke 33 is a curve-shaped component to sustain with the linking power, and is in a shape corresponding to the body shape of the livestock 100. The yoke 33 is disposed at a front end of the front thill 32; when the front thill 32 is flipped over, the rein 340 will escape at a same time, allowing the yoke 33 to be flipped upward to escape from a hump part of the livestock 100. Therefore, the livestock 100 can be dismantled easily and another head of the livestock 100 with a full strength can be drawn in to work in place of the dismantled livestock 100.

A rear end of the front thill 32 of the traction device 3 is provided transversally with the connection rod 320 which is assembled inside the urging device 4 by connection. The connection part is a pivot and the front thill 32 can be flipped on a plane against that pivot, allowing the livestock 100 to be replaced easily.

The force created by the livestock 100 acts onto the radial lever 2. However, due to the length of force arm, the radial lever 2 will be extended radially to result in the gravity effect that the tail end will drop. In particular, after the livestock power generation system 10 has been installed with the planar connection seat 31 or the urging device 4, the cantilever effect at the tail end will be explicit.

To overcome the cantilever gravity problem, the tail end position of the radial lever 2 can be added with a support device 5 which is provided with a foot stand 51. A lower end of the foot stand 51 is provided with an idler pulley 52 which is passive and can rotate clockwise and counterclockwise. The direction of operation of the idler pulley 52 aligns tangentially with the circumference around which the livestock 100 marches. Accordingly, by the assistance of the support device 5, the tail end of the radial lever 2 can be prevented from dropping.

Moreover, the support device 5 can be also connected at the position where the planar connection seat 31 or the urging device 4 drops.

By the habit where the livestock 100 can be pushed to march forward steadily, and can be driven and forced to stop marching, electricity can be generated by the working power of the livestock 100 during captivity; in addition, the livestock 100 can have a proper exercise in life to increase energy of growth. Upon implementation, a friendly management, such as the observation and comfortableness of emotion and physical status, can have a positive benefit for the power generation by an external force. Besides that, if horses, donkeys, cows or elephants are used as the livestock 100, sizable electricity can be generated under the combination and collaboration of many such animals with a great strength. The electricity generated can provide for self-sufficient use in the livestock site, can be combined with the mains to supply ambient cities or towns, or can be stored in an accumulation device to control the timing of supplying electricity. Accordingly, the economic effect of this kind of power generation system by the external force is worthy of promoting.

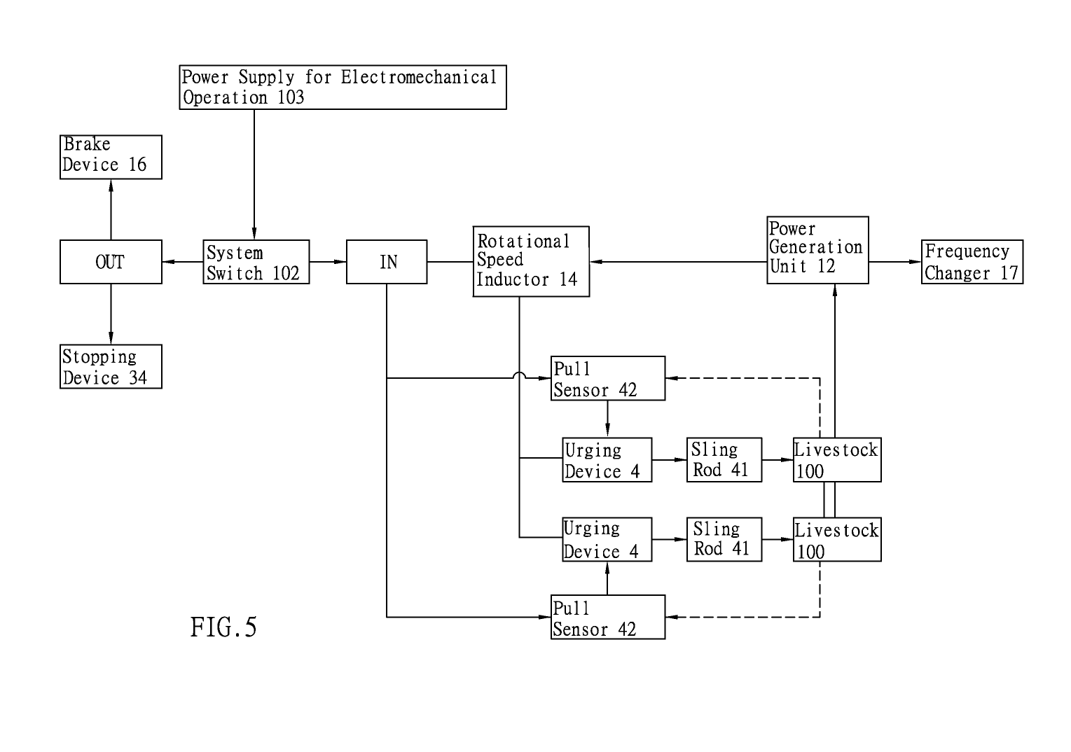

Referring to FIG. 5, to automate the execution of the livestock power generation system and to aid in the operation of electromechanical equipment, a power supply for electromechanical operation 103 and a system switch 102 are provided as the total control of whether to generate power. The system switch 102 is installed remotely, outside the working area of the livestock 100. After the system switch 102 has been activated, the rotational speed inductor 14 senses that the livestock power generation system 10 is off, and a signal is transmitted to the sling rod 41 of the urging device 4 to operate driving the livestock 100, allowing the whole livestock 100 to start marching to generate power. In the process, the rotational speed inductor 14 senses the working status (referring to FIG. 3 and FIG. 4) of the livestock 100 and directly issues a command of initiation which is transmitted synchronously to the sling rod 41 of each urging device 4 in work, so as to whip and push all the livestock 100 that are ready to work to start marching at a same time. During power generation, if the operational speed of the livestock power generation system 10 is insufficient, then after the rotational speed inductor 14 has sensed that, the urging device 4 will speed up whipping all the livestock 100 in work at a same time, until the required speed is achieved.

On the other hand, the urging device 4 is disposed inside a single traction device 3 (referring to FIG. 3), and each urging device 4 is provided with a pull sensor 42, respectively. In the herd of livestock 100, if any one head of the livestock 100 is lazy, the pull sensor 42 of that head of the livestock 100 will issue a command to the corresponding urging device 4 to push the lazy head of the livestock 100.

If the system switch 102 is to execute shutdown, then a command will be issued to order the brake device 16 and the stopping device 34 to activate the shutdown operation at a same time, and to operate the rotational speed inductor 14 to shut down simultaneously.

In the livestock power generation system 10, an output end of the power generation unit 12 can be attached with a frequency changer 17 or a transformer (not shown in the drawings) to cope with the requirement of voltage at a demand end, such that the outgoing current can achieve the required working condition.

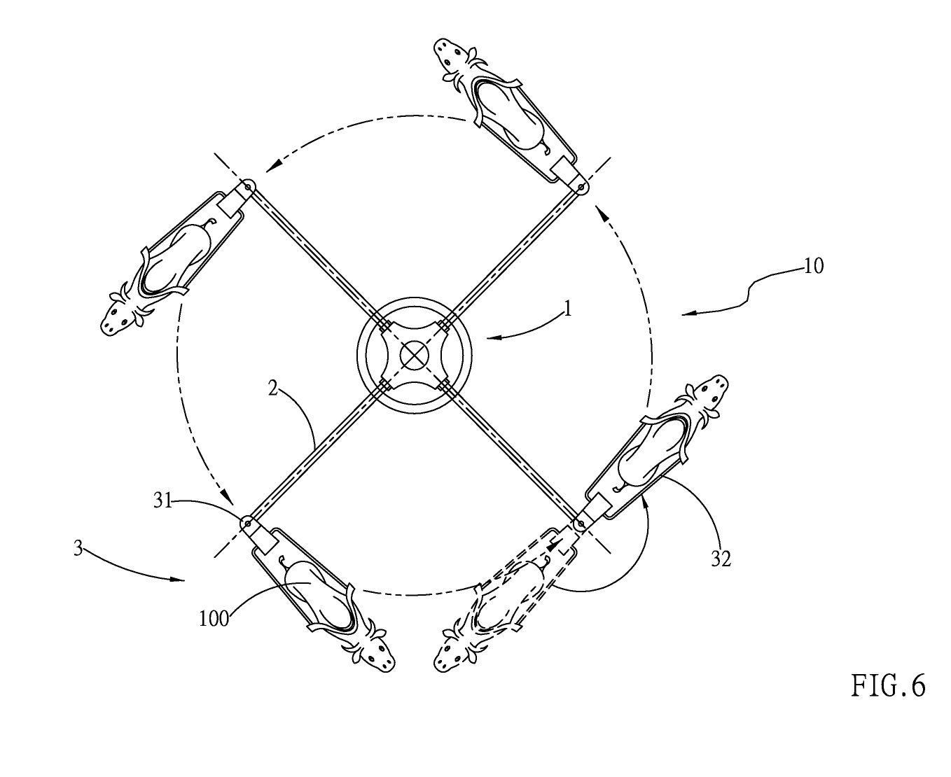

Referring to FIG. 6, the planar connection seat 31 is connected horizontally to the traction device 3, and thus, the planar connection seat 31 can swing horizontally, so that the livestock 100 can change the direction of revolution, such as in clockwise or counterclockwise. The counterclockwise revolution also allows the livestock power generation system 10 to generate electricity by cutting through the magnetic field, and changing the direction allows the left and right limbs of the livestock 100 to develop uniformly, as well.

Accordingly, in the present invention, the habit of the livestock 100 (referring to all of the abovementioned drawings) is utilized to generate electricity through the change in the passive device 1. The passive device 1 is put on the land surface and electricity is generated by the planar revolution. The entire passive device 1 can be dismantled and transported; therefore, the land will be damaged less or can be rest for maintenance. In addition, by the linking of the gearshift 13, the requirement of the working feature for the speed matching of the livestock power generation unit 12 can be changed; it will be safer when the radial seat 11 of the passive device 1 rotates slowly. Furthermore, through the assistance of the flywheel (not shown in the drawings), the power operation of the working axis of the livestock power generation system 10 can be more stable. The system switch 102 can be disposed off-site and the manager will not need to enter into the working area. Therefore, the safety of the manager can be maintained.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A livestock power generation system, being a power generation system which produces revolution to cut through electric current to generate electricity by using habit of the livestock, comprising:
a passive device, the passive device being put on a land surface horizontally, a working axis of the passive device being perpendicular to the land surface, an upper end of the passive device being provided with a radial seat which is linked to a power generation unit through a gearshift, and a bottom of the passive device being fixed and supported by a chassis, with the radial seat being arranged horizontally;
a power supply for electromechanical operation;
a system switch;
at least two radial levers, the radial levers being radially and equiangularly extended and assembled on the radial seat;
plural planar connection seats, the connection seats being assembled at tail ends of the radial levers;
a rotational speed inductor, the rotational speed inductor obtaining working power from the power supply for electromechanical operation, being operated by the system switch, and sensing the rotational speed of the working axis; and
plural traction devices, wherein number of the traction devices corresponding to the planar connection seats, one traction device being connected to one planar connection seat, each traction device being provided with one urging device, the traction devices obtaining the working power from the power supply for electromechanical operation and being commanded to operate by the rotational speed inductor.

2. The livestock power generation system according to claim 1, wherein the traction device is provided with a front thill which is flipped up, with an outer end of the front thill being assembled with a yoke.

3. The livestock power generation system according to claim 2, wherein a rear end of the front thill is provided with a connection rod which is connected to the urging device, with the urging device being linked to the planar connection seat.

4. The livestock power generation system according to claim 2, wherein an outer end of the front thill is provided with a stopping device which drives a rein to extend or retract by the working power.

5. The livestock power generation system according to claim 1, wherein an interior of the urging device is provided with a pull sensor which is triggered by the opening of a spring which is extended or compressed by the front and rear movement of the front thill; after being triggered, the pull sensor issuing a command to order the urging device to operate a sling rod to whip.

6. The livestock power generation system according to claim 1, wherein an output end of the power generation unit is provided with a frequency changer to output electricity stably.

7. The livestock power generation system according to claim 1, wherein the working axis of the passive device is provided with a brake device which is operated by the system switch.

8. The livestock power generation system according to claim 1, wherein the passive device is managed by a system switch, and when the system switch commands the livestock power generation system to operate, a rotational speed inductor is electrically connected to the urging device.

9. The livestock power generation system according to claim 8, wherein the system switch is disposed remotely, outside the working area of revolution on the land surface, when the livestock power generation system is operating.

10. The livestock power generation system according to claim 1, wherein the passive device is managed by the system switch, and when the system switch commands the livestock power generation system to operate, a pull sensor is electrically connected to the urging device.

11. The livestock power generation system according to claim 1, wherein when the system switch commands the power generation system to shut down, the rotational speed inductor is ordered to turn off, a brake device is ordered to operate, and a stopping device is ordered to operate the rein to command the livestock to stop marching.

12. The livestock power generation system according to claim 1, wherein the planar connection seat changes a planar angle to change marching direction of the livestock.
